(19) United States
(12) Patent Application Publication
(10) Pub. No.: US 2005/0105826 A1
(43) Pub. Date: May 19, 2005

(54) Edge detection apparatus and method

(76) Inventors: Seong-joon Yang, Seoul (KR); Hwa-sup Lim, State College, PA (US); Young-ho Lee, Seoul (KR)

Correspondence Address: STANZIONE & KIM, LLP, 1740 N STREET, N.W., FIRST FLOOR, WASHINGTON, DC, 20036, US

(21) Appl. No.: 10/927,230

(22) Filed: Aug. 27, 2004

(30) Foreign Application Priority Data
Nov. 18, 2003 (KR) 2003-81526

(51) Int. Cl. H01J 40/14

(52) U.S. Cl. 382/286

(57) ABSTRACT

An edge detection apparatus and method includes a mapping part to map a two-dimensional plane of an input image into a three-dimensional vector surface, a coefficient calculation part to calculate coefficients for an equation of planes each formed with plural pixels and mapped by the mapping part, an angle calculation part to calculate an angle formed by a normal vector with respect to the equation of planes, and an edge decision part to determine whether an edge exists based on the angle calculated by the angle calculation part. Accordingly, the edge detection apparatus can not only efficiently detect edges without sensitivity to noise over high frequency bands, but also adaptively perform edge detections depending on the extent of noise so as to provide diverse adjustment points for the edge detections.

### CROSS-REFERENCE TO RELATED APPLICATIONS

This application claims benefit under 35 U.S.C. § 119 from Korean Patent Application No. 2003-81526, filed on Nov. 18, 2003, in the Korean Intellectual Property Office, the entire content of which is incorporated herein by reference.

### BACKGROUND OF THE INVENTION

1. Field of the Invention

The present general inventive concept relates to an edge detection apparatus and method of effectively detecting edges from input images, and more particularly, to an edge detection apparatus and method capable of efficiently detecting edges without sensitiveness to noise at high frequency components.

2. Description of the Related Art

Image edges refer to boundary regions among objects on an image or to discrete portions of gray-level line. As an edge detection method widely used so far, there is an edge detection method using Sobel masks.

FIG. 1 is a block diagram schematically showing a conventional edge detection apparatus 10 using Sobel masks. Referring to FIG. 1, the edge detection part 10 receives input image data and multiplies pixel values of the received image data by a predetermined mask weighting factor having a magnitude of 3×3 Sobel masks or a magnitude of 5×5 Soble masks.

Next, the edge detection part 10 calculate a sum of values obtained from the multiplication of the mask weighting factor by the pixel values of the received image data. Thereafter, the edge detection part 10 calculates absolute values with respect to the values obtained from the multiplication of the mask weighting factor by the pixel values of the received image data. The edge detection part 10 repeats the above procedures while shifting pixels one by one in an X direction and a Y direction, observes changes of the magnitudes of the absolute values obtained in the X direction and the Y direction, and detects edge portions. Here, portions at which the magnitudes of the absolute values are abruptly increased become the edge portions. Basically, edges are the portions at which discrete gray levels in an image exist, so the edges are obtained through calculations of gray level difference values among neighboring pixels about a pixel.

A magnitude of 3×3 or 5×5 is generally used as a mask. In FIG. 1, Hx (m,n) and Hy (m,n) denote a 3×3 Sobel mask, and x and y denote the X direction (vertical direction) and Y direction (horizontal direction), respectively. Here, as the mask magnitude is getting smaller, an edge localization performance is getting better. However, in this case, undesired components, such as noise, are detected as the edges, thereby causing a problem of degrading an edge detection performance. Further, as the mask magnitude is getting larger, the probability of edge detection is getting higher in characteristics, which still causes a problem of deteriorating the edge localization performance.

Accordingly, in a case that noise components exist in an image, the edges are detected through Sobel masks and then the noise components are removed using a low-pass filter so that the noise components are prevented from being detected as the edges. That is, as shown in FIG. 2, the edge detection part 10 uses edge detection operators, such as Hx (m,n) and Hy (m,n), to detect edges of input image data and sends the detected edges to a low-pass filter 20.

In general, noise is relatively smaller in magnitude than other significant patterns in an image, so the edge components of the noise are distributed over high frequency bands. Therefore, the low-pass filter 20 filters edge data that the edge detection part 10 sends, and removes the edge components of the noise that are distributed over the high frequency bands.

However, although the above conventional edge detection apparatus effectively removes the edge components of the noise using the low-pass filter after edge detections, the conventional edge detection apparatus has a problem in that edge components of indispensable objects may also be removed.

### SUMMARY OF THE INVENTION

In order to solve the foregoing and/or other problems, it is an aspect of the present general inventive concept to provide an edge detection apparatus and method capable of efficiently detecting edges without being sensitive to noise over high frequency bands.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an edge detection apparatus that include a mapping part to map a two-dimensional plane of an input image into a three-dimensional vector surface, a coefficient calculation part to calculate coefficients for an equation of planes each formed with a plurality of pixels and mapped by the mapping part, an angle calculation part to calculate an angle formed by normal vectors of planes, and an edge decision part to determine whether an edge exists based on the angle calculated by the angle calculation part.

In an aspect of the present general inventive concept, the mapping part includes a plane-sorting part to sort the input image plane formed with four pixels into each planar shape, the planer shape including a first planar shape perpendicular to an Z axis, a second planar shape oriented in one direction, and a third planar shape formed with two adjoined planes, and a direction search part to search for an edge direction of a plane formed with the four pixels if the planar shape formed with the four pixels and sorted by the plane-sorting part is the third planar shape formed with the two adjoined planes. The mapping of the two-dimensional plane is performed on the image based on the planar shape sorted by the plane-sorting part and the edge direction searched by the direction search part.

In another aspect of the present general inventive concept, the coefficient calculation part calculates the coefficients by the following plane equation based on three coordinate values (X₀, Y₀, Z₀), (X₁, Y₁, Z₁), and (X₂, Y₂, Z₂) existing on the same plane:
ax+by+cz=1,
wherein a, b, and c are coefficients expressed as

$$a = \frac{\vert {D}_{x} \vert}{\vert D \vert} , b = \frac{\vert {D}_{y} \vert}{\vert D \vert} , c = \frac{\vert {D}_{z} \vert}{\vert D \vert} ,$$

respectively, and

$$D = ( \begin{matrix}{x}_{0} & {y}_{0} & {z}_{0} \\ {x}_{1} & {y}_{1} & {z}_{1} \\ {x}_{2} & {y}_{2} & {z}_{2}\end{matrix} ) .$$

In yet another aspect of the present general inventive concept, the angle calculation part calculates the angle formed by the normal vectors using the following equation based on the coefficients calculated by the coefficient calculation part:

$$θ = {cos}^{- 1} ( \frac{\sqrt{{a}^{2} + {b}^{2}}}{\sqrt{{a}^{2} + {b}^{2} + {c}^{2}}} ) ,$$

in which a, b, and c denote coefficients for the plane equation.

In yet another aspect of the present general inventive concept, the edge detection apparatus further include a threshold value storage part to store the predetermined number of threshold values set in different angles, and an edge region storage part to store edge regions which are set in correspondence to the threshold values stored in the threshold value storage part. Here, the edge decision part can determine an edge region set based on the angle calculated by the angle calculation part.

The foregoing and/or other aspect of the present general inventive concept may also be achieved by providing an edge detection method which includes mapping a two-dimensional plane of an input image into a three-dimensional vector surface, calculating coefficients for an equation of planes each formed with a plurality of pixels and mapped in the mapping operation, calculating an angle formed by normal vectors with respect to the equation of planes, and deciding whether an edge exists based on the angle calculated in the angle calculating operation.

In an aspect of the present general inventive concept, the edge detection method further include sorting the input image plane formed with four pixels into each planer shape, the planer shape including a first planar shape perpendicular to an Z axis, a second planar shape oriented in one direction, and a third planar shape formed with two adjoined planes, and searching for an edge direction of a plane formed with the four pixels, if the planar shape formed with the four pixels and sorted in the input image plane sorting operation is the third planar shape formed with the two adjoined planes. Here, the mapping of the two-dimensional plane includes performing the mapping on the image based on the planar shape sorted in the input image plane sorting operation and the edge direction searched in the searching operation.

In another aspect of the present general inventive concept the calculating of the coefficients includes calculating the coefficients by the following plane equation based on three coordinate values (X₀, Y₀, Z₀), (X₁, Y₁, Z₁), and (X₂, Y₂, Z₂) existing on the same plane:
ax+by+cz=1,
wherein a, b, and c are coefficients expressed as

$$a = \frac{\vert {D}_{x} \vert}{\vert D \vert} , b = \frac{\vert {D}_{y} \vert}{\vert D \vert} , c = \frac{\vert {D}_{z} \vert}{\vert D \vert} ,$$

respectively, and

$$D = ( \begin{matrix}{x}_{0} & {y}_{0} & {z}_{0} \\ {x}_{1} & {y}_{1} & {z}_{1} \\ {x}_{2} & {y}_{2} & {z}_{2}\end{matrix} )$$

In yet another aspect of the present general inventive concept the calculating of the angle includes calculating the angle formed by the normal vectors by the following equation based on the coefficients calculated in the input image plane sorting operation:

$$θ = {cos}^{- 1} ( \frac{\sqrt{{a}^{2} + {b}^{2}}}{\sqrt{{a}^{2} + {b}^{2} + {c}^{2}}} ) ,$$

in which a, b, and c denote coefficients for the plane equation.

In still another aspect of the present general inventive concept, the edge detection method further includes comparing the angle calculated in the angle calculating operation with the predetermined number of threshold values set as different angles, and deciding an edge region corresponding to the angle calculated in the angle calculating operation according to a result of the comparing operation.

In another aspect of the present general inventive concept, the edge detection apparatus can adaptively detect edges based on the extent of noise.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram schematically showing a conventional edge detection apparatus using a conventional Sobel mask;

FIG. 2 is a view schematically showing a conventional edge detection apparatus using a conventional low-pass filter;

FIG. 3 is a block diagram schematically showing an edge detection apparatus according to an embodiment of the present general inventive concept;

FIG. 4 is a flow chart showing an edge detection method for the edge detecting apparatus of FIG. 3 according to another embodiment of the present general inventive concept;

FIG. 5 is a view showing an edge direction and gradient in mapping a two-dimensional plane into a three-dimensional space;

FIG. 6 is a view showing two planes met in mapping a two-dimensional plane into a three-dimensional space;

FIG. 7 is a view explaining a search for an edge direction;

FIG. 8 is a view explaining a method of calculating coefficients and gray values for an equation of a plane;

FIG. 9A is a view showing an edge detection area when a base is long in length, and FIG. 9B is a view showing an edge detection area when the base is short in length;

FIG. 10 is a view showing variations of values of tan 0 based on magnitudes of angles θ; and

FIG. 11 is a view showing patterns of a speckle noise.

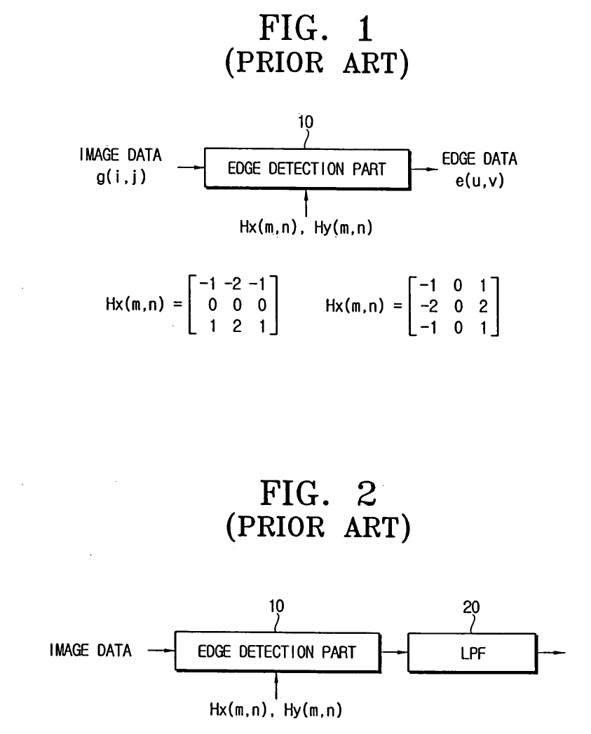

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

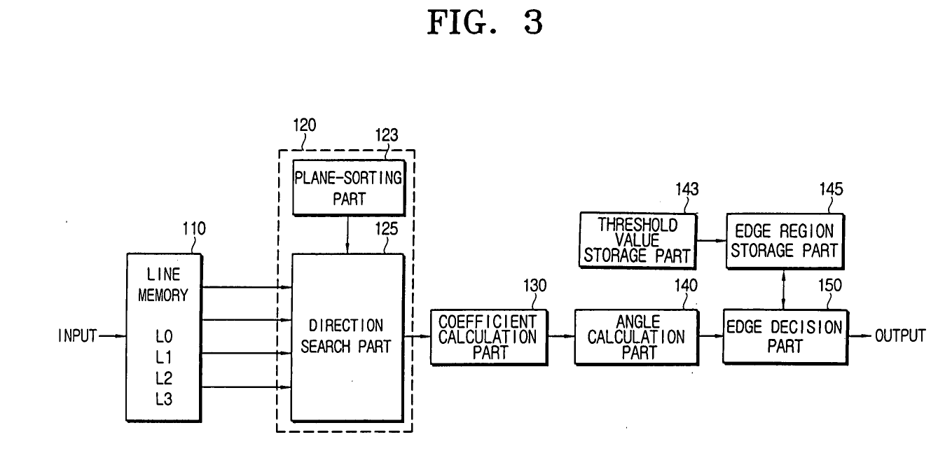

FIG. 3 is a block diagram schematically showing an edge detection apparatus according to an embodiment of the present general inventive concept. Referring to FIG. 3, the edge detection apparatus may have a line memory 110, a mapping part 120, a coefficient calculation part 130, an angle calculation part 140, a threshold value storage part 143, an edge region storage part 145, and an edge decision part 150. Here, the mapping part 120 may have a plane-sorting part 123 and an orientation search part 125.

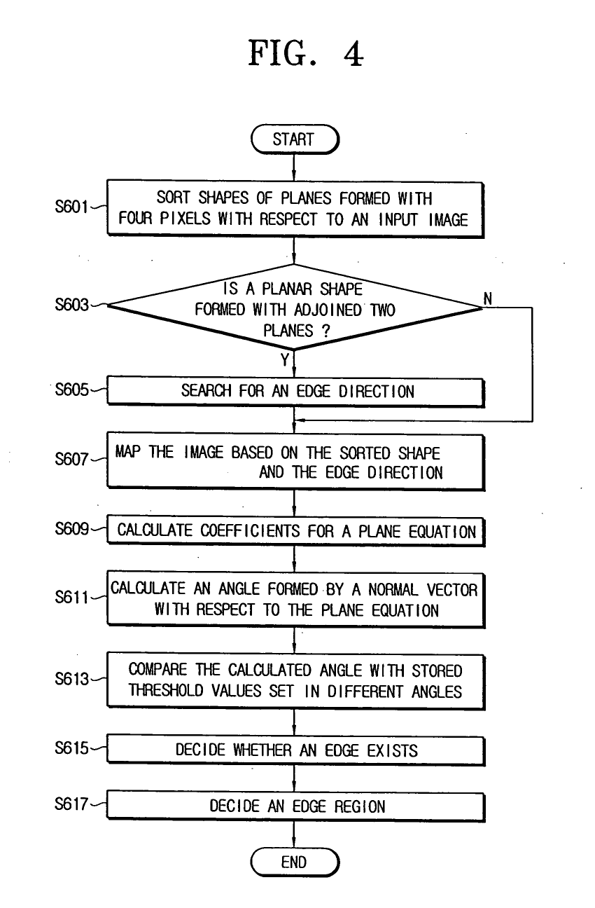

FIG. 4 is a flow chart showing an edge detection method for the edge detection apparatus shown in FIG. 3. Descriptions will be made in detail on not only operations of the edge detection apparatus but also the edge detection method thereof.

Referring to FIGS. 3 and 4, the line memory 110 can sequentially delay an input image signal to form rows arranged in a horizontal direction and sequentially delay the rows-arranged image signal to form columns in a vertical direction, thereby forming a matrix. As such, the input image signal delayed in the horizontal direction and the vertical direction can form one image corresponding to the matrix. The image formed by the line memory 110 can be constructed into, a two-dimensional plane.

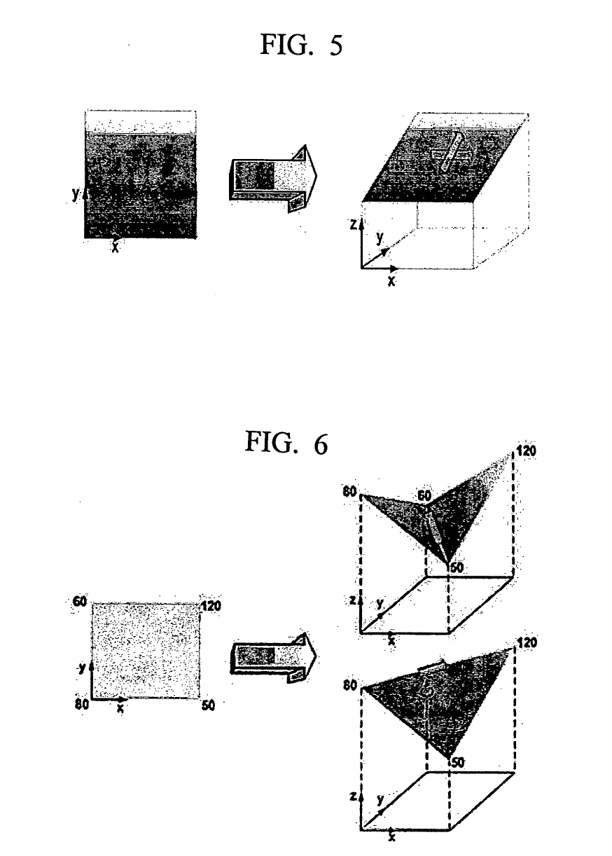

The plane-sorting part 123 provided in the mapping part 120 can sort two-dimensional planes of an input image into planes perpendicular to a Z axis, planes oriented in one direction, and planes formed with two adjoined planes, with respect to a plane formed with four pixels of an input image (S601). Through the sorting operation, in a case that the two-dimensional plane of the image is mapped into a three-dimensional space as shown in FIG. 5, the mapped image may have an edge direction, based on luminance levels, and a gradient perpendicular to the edge direction. In an aspect of the present general inventive concept the four pixels of the input image may be pixels adjacent to one another in order to sort precise shapes of planes. However, the four pixels are not limited to the adjacent pixels, but can be pixels located in various positions.

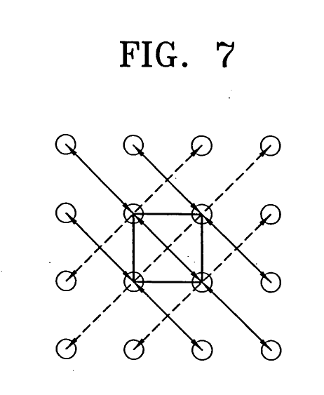

In a case that a plane formed with the four pixels and sorted by the plane-sorting part 123 has a planar shape formed with the two adjoined planes (S603), the direction search part 125 provided in the mapping part 120 can search for the edge direction of the plane formed with the four pixels (S605). That is, when the two-dimensional plane formed with the four pixels is mapped into the three-dimensional space, the plane can be mapped into a first planar shape perpendicular to the Z axis, a second planar shape oriented in one direction, or a third planar shape formed with the two adjoined planes as shown in FIG. 6. At this time, if the two-dimensional plane formed with the four pixels is converted into the third planar shape formed with the two adjoined planes when mapped into the three-dimensional space, the edge direction can vary depending upon the planar shape. In this case, the direction search part 125 takes neighboring pixels having levels similar to input pixels to search for the edge direction. Here, as shown in FIG. 7, the direction search part 125 can search the edge direction by performing the edge direction search operation in one direction from differences of pixel values disposed on a path connecting the neighboring pixels having the levels similar to the input pixels with respect to a reference direction. After the searching of the edge direction in the one direction is completed, the direction search part 125 can search for the edge direction by performing the edge direction search operation in a different direction from differences of pixel values disposed on another path connecting the neighboring pixels having the levels similar to the input pixels.

The mapping part 120 can perform the mapping operation on an image based on shapes of planes, sorted by the plane-sorting part 123, and edge directions searched by the direction search part 125 (S607). That is, if the shapes of the planes are sorted by the plane-sorting part 123, and the edge directions are searched by the direction search part 125, the mapping part 125 can map individual pixels of the two-dimensional plane into the three-dimensional space based on the plane shapes and the edge directions.

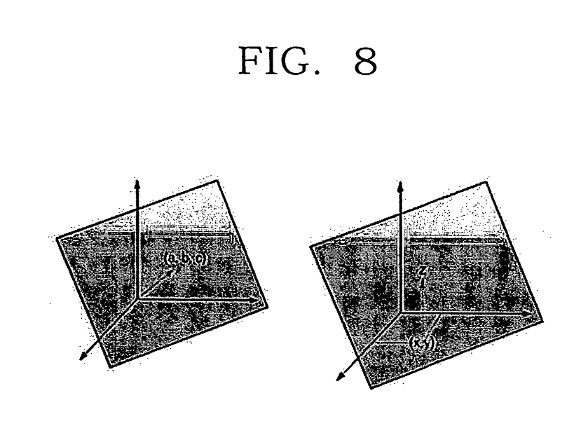

The coefficient calculation part 130 can calculate coefficients for each equation of individual planes formed with the corresponding pixels which are mapped into the three-dimensional space by the mapping part 120 (S609). That is, as shown in FIG. 8, provided that (a, b, c) is denoted as a normal vector with respect to each mapped plane formed with the corresponding pixels, the equation of the mapped planes can be expressed as follows:
ax+by+cz=1 [Equation 1]

Three arbitrary points (X₀, Y₀, Z₀), (X₁, Y₁, Z₁), and (X₂, Y₂, Z₂) disposed on the plane of the third planar shape are substituted into Equation 1, the following equations are obtained.
ax₀+by₀+cz₀=1
ax₁+by₁+cz₁=1
ax₂+by₂+cz₂=1 [Equation 2]

From Equation 2, the coefficients a, b, and c can be calculated according to Cramer's rule. That is,

$$a = \frac{\vert Dx \vert}{\vert D \vert} , b = \frac{\vert Dy \vert}{\vert D \vert} , c = \frac{\vert Dz \vert}{\vert D \vert} , and D = ( \begin{matrix}{x}_{0} & {y}_{0} & {z}_{0} \\ {x}_{1} & {y}_{1} & {z}_{1} \\ {x}_{2} & {y}_{2} & {z}_{2}\end{matrix} )$$

Here, a singular value of D=0 can be detected through the plane-sorting part 123 of the mapping part 120, and other equations, such as cz=1, ax+cz=1, by+bz=1, etc., can be applied to obtain each equation of the planes.

The angle calculation part 140 can calculate an angle formed between the normal vectors of the respective plane equations to which the coefficients calculated by the coefficient calculation part 130 are applied (S611). At this time, the angle calculation part 140 can calculate the angle formed by the normal vectors based on the coefficients calculated by the coefficient calculation part 130 using the following equation 3.

$$θ = {cos}^{- 1} ( \frac{\sqrt{{a}^{2} + {b}^{2}}}{\sqrt{{a}^{2} + {b}^{2} + {c}^{2}}} ) , \qquad [ Equation 3 ]$$

wherein a, b, and c are coefficients for the plane equation calculated by the coefficient calculation part 130.

The threshold value storage part 143 can store predetermined threshold angles which are different from one another. The threshold angles stored in the threshold value storage part 143 may be used as an angle range in which there is no need to perform edge detections, and angle ranges each set for each procedure to indicate the extent of edge detection executions and so on.

The edge region storage part 145 can establish and store edge regions corresponding to the threshold angles stored in the threshold value storage part 143. Here, the edge regions indicate region values each set for each procedure to adaptively point out the detected edge according to an angle calculated by the angle calculation part 140.

When the angle calculation part 140 calculates an angle formed with the normal vectors, the edge decision part 150 can compare the calculated angle value with the individual threshold values stored in the threshold storage part 143 (S613). At this time, the edge decision part 150 can decide for the first time whether there exists an edge based on a result of the comparison of the calculated angle with the individual threshold angles stored in the threshold value storage part 143 (S615). If it is decided that the edge exists, the edge decision part 150 searches for the edge regions from the edge region storage part 145 and decides an edge region corresponding to the calculated angle (S617).

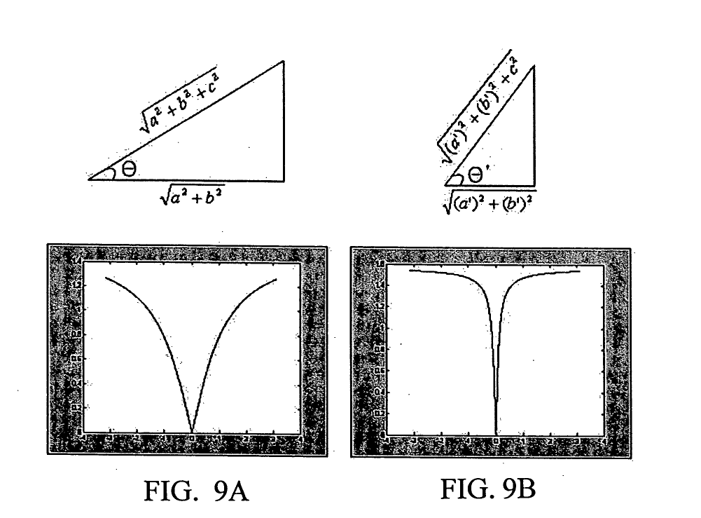

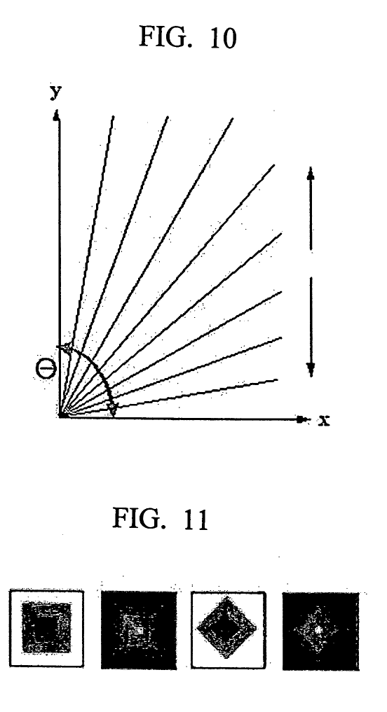

At this time, the extent of the edge detection can vary depending on a base length, that is, \sqrt{a²+b²}, adjusted according to an amount of noise measured in an outside of a signal graph, as shown in FIGS. 9 and 10. FIG. 9A shows an edge detection area (frequency band) when the base length is long, and FIG. 9B shows another edge detection area (frequency band) when the base length is short.

FIG. 10 is a view showing variations of tan E based on the magnitudes of an angle θ. Referring to FIG. 10, a detection area can be getting smaller as the angle θ is getting smaller, but the sensitivity to the edge detection is getting higher. Accordingly, the possibility of fine edge detections goes higher as the angle θ becomes smaller. Here, the angle θ increases or decreases depending upon patterns of a speckle noise. The speckle noise may be an impulse noise, and its pattern can feature a shape converging into one direction or a shape spreading from one direction. FIG. 11 shows some exemplary patterns of the speckle noise.

It is possible to perform the fine edge detections using noise features by decreasing the base length and increasing the edge detection area when noise exists, more than a reference value or by increasing the base length and decreasing the edge detection area when noise exists less that the reference value.

According to the present invention, the edge detection apparatus can efficiently detect edges without sensitivity to noise over high frequency bands.

Further, the edge detection apparatus can adaptively perform edge detections depending on the extent of noise so as to provide diverse adjustment points for the edge detections.

The foregoing embodiment and advantages are merely exemplary and are not to be construed as limiting the present invention. The present teaching can be readily applied to other type of apparatuses. Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An edge detection apparatus, comprising:
a mapping part to map a two-dimensional plane of an input image into a three-dimensional vector surface;
a coefficient calculation part to calculate coefficients for each equation of planes each formed with a plurality of pixels of the input image and mapped by the mapping part;
an angle calculation part to calculate an angle formed by normal vectors with respect to the planes using the coefficients; and
an edge decision part to determine whether an edge exists based on the angle calculated by the angle calculation part.

2. The edge detection apparatus as claimed in claim 1, wherein the mapping part includes:
a plane-sorting part to sort an input image plane formed with four pixels of the input image into one of a first planar shape perpendicular to an Z axis, a second planar shape oriented in one direction, and a third planar shape formed with two adjoined planes; and
a direction search part to search for an edge direction of the input image plane formed with the four pixels if the one planar shape formed with four pixels and sorted by the plane-sorting part is the third planar shape formed with the two adjoined planes, so that the mapping is performed on the input image based on the one planer shape sorted by the plane-sorting part and the edge direction searched by the direction search part.

3. The edge detection apparatus as claimed in claim 2, wherein the coefficient calculation part calculates the coefficients based on three coordinate values (X₀, Y₀, Z₀), (X₁, Y₁, Z₁), and (X₂, Y₂, Z₂) existing on the same input image plane using the following plane equation:
ax+by+cz=1,
where a, b, and c are coefficients expressed as
$$a = \frac{\vert {D}_{x} \vert}{\vert D \vert} , b = \frac{\vert {D}_{y} \vert}{\vert D \vert} , c = \frac{\vert {D}_{z} \vert}{\vert D \vert} ,$$
respectively, and
$$D = ( \begin{matrix}{x}_{0} & {y}_{0} & {z}_{0} \\ {x}_{1} & {y}_{1} & {z}_{1} \\ {x}_{2} & {y}_{2} & {z}_{2}\end{matrix} ) .$$

4. The edge detection apparatus as claimed in claim 3, wherein the angle calculation part calculates the angle formed by the normal vector based on the coefficients calculated by the coefficient calculation part using the following equation:
$$θ = {cos}^{- 1} ( \frac{\sqrt{{a}^{2} + {b}^{2}}}{\sqrt{{a}^{2} + {b}^{2} + {c}^{2}}} ) ,$$
in which a, b, and c denote coefficients for the plane equation.

5. The edge detection apparatus as claimed in claim 4, further comprising:
a threshold value storage part to store the predetermined number of threshold values set in different angles; and
an edge region storage part to store edge regions set, respectively, in correspondence to the threshold values stored in the threshold value storage part, and the edge decision part deciding an edge region set based on the angle calculated by the angle calculation part.

6. An edge detection method, comprising:
mapping a two-dimensional plane of an input image into an input image plane of a three-dimensional vector surface;
calculating coefficients for an equation of planes, each plane formed with a plurality of pixels of the input image and mapped by the input operation;
calculating an angle formed by normal vectors with respect to the planes using the coefficients; and
deciding whether an edge exists based on the angle calculated by the calculating operation.

7. The edge detection method as claimed in claim 6, further comprising:
sorting the input image plane formed with four pixels of the input image into a planar shape corresponding to one of a first planar shape perpendicular to an Z axis, a second planar shape oriented in one direction, and a third planar shape formed with two adjoined planes; and
searching for an edge direction of the input image plane formed with the four pixels if a planar shape formed with the four pixels and sorted by the sorting operation is the third planar shape formed with the two adjoined planes, wherein the mapping operation comprises mapping on the image based on the planar shape sorted by the sorting operation and the edge direction searched by the searching operation.

8. The edge detection method as claimed in claim 7, wherein the calculating of the coefficients comprises calculating the coefficients based on three coordinate values (X₀, Y₀, Z₀), (X₁, Y₁, Z₁), and (X₂, Y₂, Z₂) existing on the same plane of the third planar shape using the following plane equation:
ax+by+cz=1,
where a, b, and c are coefficients expressed as
$$a = \frac{\vert {D}_{x} \vert}{\vert D \vert} , b = \frac{\vert {D}_{y} \vert}{\vert D \vert} , c = \frac{\vert {D}_{z} \vert}{\vert D \vert} ,$$
respectively, and
$$D = ( \begin{matrix}{x}_{0} & {y}_{0} & {z}_{0} \\ {x}_{1} & {y}_{1} & {z}_{1} \\ {x}_{2} & {y}_{2} & {z}_{2}\end{matrix} ) .$$

9. The edge detection method as claimed in claim 8, wherein the calculating of the angle comprises calculating the angle formed by the normal vector based on the coefficients calculated in the calculating operation of the coefficients, using the following equation:
$$θ = {cos}^{- 1} ( \frac{\sqrt{{a}^{2} + {b}^{2}}}{\sqrt{{a}^{2} + {b}^{2} + {c}^{2}}} ) ,$$
in which a, b, and c denote coefficients for the plane equation.

10. The edge detection method as claimed in claim 9, further comprising:
comparing the angle with the predetermined number of threshold values corresponding to different angles; and
deciding an edge region corresponding to the angle according to a result of the comparing operation.

11. An edge detection apparatus comprising:
a mapping part to map a two-dimensional plane of an input into a three-dimensional space to generate a shape formed with two adjoined planes;
an angle calculation part to calculate an angle formed by normal vectors of the two adjoined planes; and
an edge decision part to decide whether an edge exists in the input image, according to the angle.

12. The edge detection apparatus as claimed in claim 11, wherein the two-dimensional plane is formed with four pixels of the input image.

13. The edge detection apparatus as claimed in claim 13, wherein the four pixels are represented by first and second axes in the two-dimensional plane, and the four pixels are represented by the first and second axes and a third axis according to a luminance level of each pixel.

14. The edge detection apparatus as claimed in claim 11, wherein the mapping part receives the input image in a matrix form having the four pixels.

15. The edge detection apparatus as claimed in claim 11, wherein the mapping part maps the two-dimensional plane according to a planer shape and an edge direction of the input image.

16. The edge detection apparatus as claimed in claim 11, further comprising:
a coefficient calculation part to calculate coefficients corresponding to each of the two adjoined planes,
wherein the normal vectors are calculated from the calculated coefficients.

17. The edge detection apparatus as claimed in claim 11, further comprises:
a threshold value storage part to store one or more threshold values,
wherein the edge decision part compares the angle with at least one of the one or more threshold values to determine whether the edge exists in the input image.

18. An edge detection apparatus comprising:
a mapping part to map a two-dimensional plane of an input image into a three-dimensional space to generate a shape formed with at least two planes; and
an angle calculation part to generate an angle corresponding to the two planes; and
an edge decision part to decide whether an edge exists in the input image, according to the angle.

19. The edge detection apparatus as claimed in claim 18, wherein the two-dimensional plane is formed with at least four pixels contained in the input image, and the two planes are adjoined in the three-dimensional space.

20. An edge detection method comprising:
mapping a two-dimensional plane of an input image into a three-dimensional space to generate a shape formed with at least two planes;
generating an angle corresponding to the two planes; and
deciding whether an edge exists in the image, according to the angle.
